(19) United States
(12) Patent Application Publication
(10) Pub. No.: US 2014/0083370 A1
(43) Pub. Date: Mar. 27, 2014

(54) ANTI-THEFT, TAMPER-RESISTANT DOG HARNESS AND LEASH SYSTEM

(71) Applicants: Ryan Matthew Grandfield, San Jose, CA (US); Jill Noel Klingensmith, San Jose, CA (US)

(72) Inventors: Ryan Matthew Grandfield, San Jose, CA (US); Jill Noel Klingensmith, San Jose, CA (US)

(21) Appl. No.: 13/628,423

(22) Filed: Sep. 27, 2012

(51) Int. Cl. A01K 27/00

(52) U.S. Cl. CPC A01K 27/002; A01K 27/003
USPC 119/792

(57) ABSTRACT

An anti-theft, tamper-resistant dog harness and leash system for walking a dog and locking a dog securely to a fixed object. The system includes a wire-reinforced leash with a padlock at the end connecting to a wire-reinforced harness. Wire is integrated into the harness and leash so that they cannot easily be cut. The connection of the padlock to the harness prevents harness removal from the dog. The locking mechanism of the padlock may comprise of a key or combination lock. The locking mechanism and tamper-resistance of the system does not interfere with the normal use of the harness and leash system.

### RELATED APPLICATIONS

Not applicable

### BACKGROUND OF THE INVENTION

Walking the dog while conducting errands has become increasingly popular as a healthy, active option for both the dog and the owner. Unfortunately, fear of dog theft discourages owners from tying up their dog outside businesses or eating establishments. Combating dog theft, therefore, is a necessary step towards increasing the ability of dog owners to bring their dogs with them wherever they go.

A consistent finding is that stolen dogs, regardless of theft location, are not locked at all, and are instead secured using a leash looped through itself that requires little effort to remove. Some dogs are stolen from places that are assumed to be safe, when in reality they are not. Others are left unattended and unlocked for short periods of time. For example, sometimes dog owners leave their dog tied to a fixed object for a just a minute or two while they run into a store, only to find their dog gone when they exit. While all locks can be overcome if the opportunity is present and a thief is suitably equipped, inadequate securing practices create a situation conducive for the thief. Observing more-secure locking practices would, at the very least, reduce opportunistic thefts.

What is needed is a convenient and a lightweight locking system that is integrated with the dog harness and leash. When the system is being used for walking, the locking aspect should not interfere.

The invention is directed to overcoming the problems and providing for the needs set forth above.

### SUMMARY OF THE INVENTION

To solve one of more of the problems set forth above, in an exemplary implementation of the invention, an anti-theft, tamper-resistant dog harness and leash system is provided. An exemplary dog harness and leash according to principles of the invention includes a harness and leash providing attachment to the dog and providing a loop for which a user's hand may exert a force through the system and to the dog as well as use for looping itself around a fixed object for securing the dog. A leash is constructed with metal wires integrated into the fabric of the leash. The leash is coupled to the harness using a key or combination actuated padlock. The padlock connects the two open ends of the harness, which may also be connected with a quick-releasing buckle or clasp. The harness is constructed with metal wires integrated into the fabric of the harness.

The dog harness and leash system may also be constructed with metal wire strand or cable instead of metal wire.

The dog harness and leash system may also be constructed with other flexible yet cut-resistant materials such as polymer or a combination of polymer and metal.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function, and manner of operation, are deemed readily apparent and obvious to one skilled in the art, and all equivalent relationships to those illustrated in the drawings and described in the specification are intended to be encompassed by the present invention. The above description and drawings below are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

### DESCRIPTION OF THE DRAWINGS

The foregoing and other aspects, objects, features and advantages of the invention will become better understood with reference to the following description, appended claims and accompanying drawings, where:

FIG. 1 is a sectional view of an exemplary leash assembly with wire cable integrated in tubular webbing according to the principles of the invention; and

FIG. 2 is a sectional view of an exemplary leash assembly with wire cable integrated in tubular webbing according to the principles of the invention; and

FIG. 3 is a sectional view of an exemplary leash assembly with wires integrated in tubular webbing according to the principles of the invention; and

FIG. 4 is a perspective view of an exemplary leash hand loop assembly with wire cable integrated in the fabric and connected to itself according to the principles of the invention; and

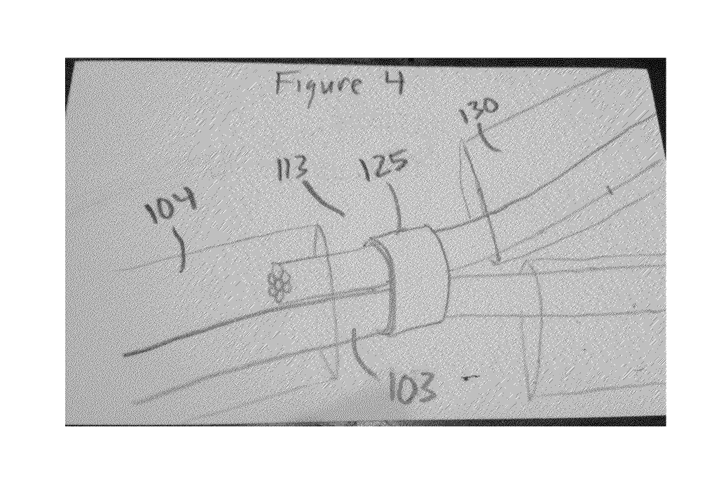

FIG. 5 is a perspective view of an exemplary leash and padlock assembly with wire cable integrated in the fabric according to the principles of the invention; and

FIG. 6 is a sectional view of an exemplary harness assembly with wire cable integrated between two layers of fabric according to the principles of the invention; and

FIG. 7 is a sectional view of an exemplary harness assembly with wire cable integrated between two layers of fabric according to the principles of the invention; and

FIG. 8 is a sectional view of an exemplary harness assembly with wires integrated between two layers of fabric according to the principles of the invention; and

FIG. 9 is a sectional view of an exemplary harness assembly with wire cable integrated between two layers of fabric according to the principles of the invention; and

FIG. 10 is a perspective view of exemplary leash-padlock-harness assembly according to the principles of the invention; and

FIG. 11 is a perspective view of a locked dog equipped with an exemplary anti-theft, tamper-resistant dog harness and leash system in a locked configuration according to the principles of the invention; and

Those skilled in the art will appreciate that the figures are not intended to be drawn to any particular scale: nor are the features intended to illustrate every embodiment of the invention. The invention is not limited to the exemplary embodiments depicted in the figures or the types of mating locking components, configurations, shapes, relative sizes, ornamental aspects or proportions shown in the figures.

### DETAILED DESCRIPTION

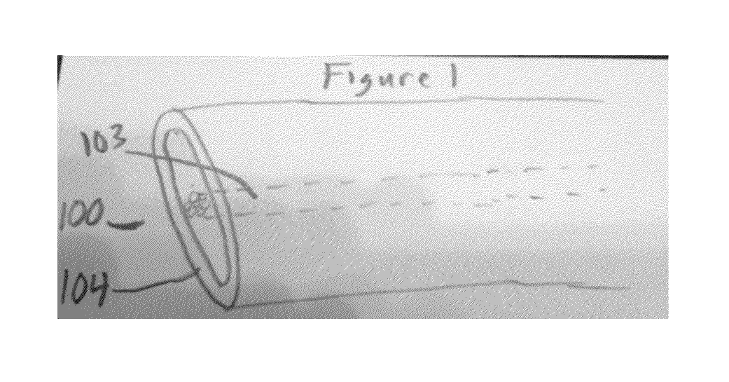

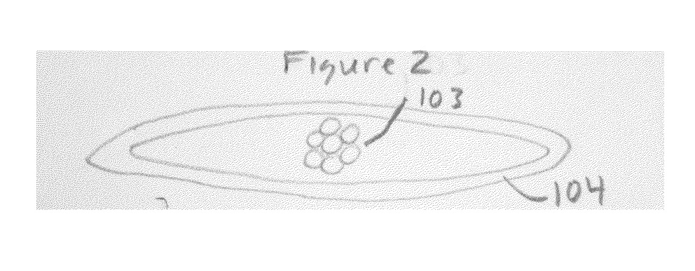

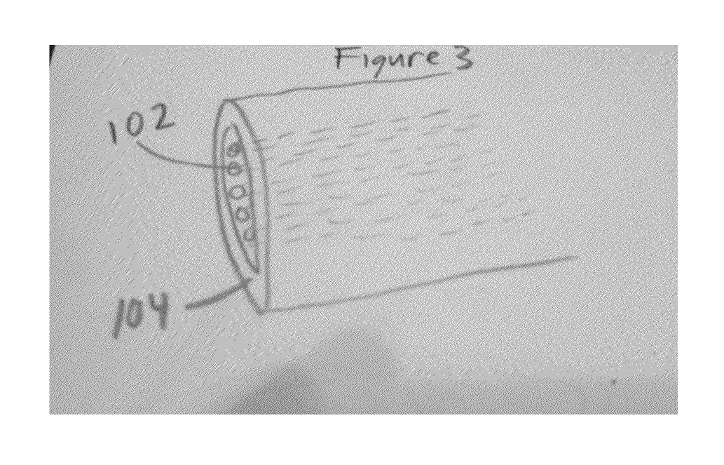

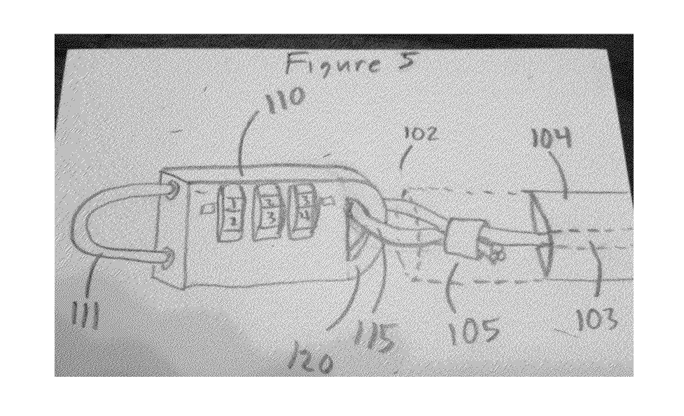

Referring to FIGS. 1, 2 and 3, a leash 100 with integrated wire in the form of wires 102, strands or cable 103 inside tubular webbing 104 according to the principles of the invention is shown. In FIG. 5 the leash 100 is connected 102 to the padlock 110. The cable 103 is threaded through the padlock 120 and looped back onto itself 115. The cable 103 is secured within a crimped fitting 105. The tubular webbing 104 can extend over the top of the fitting 105.

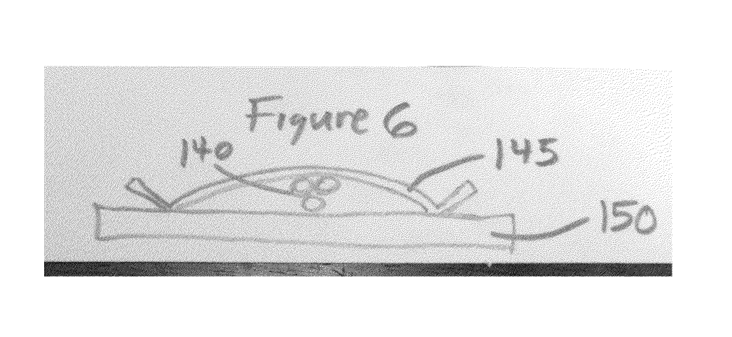

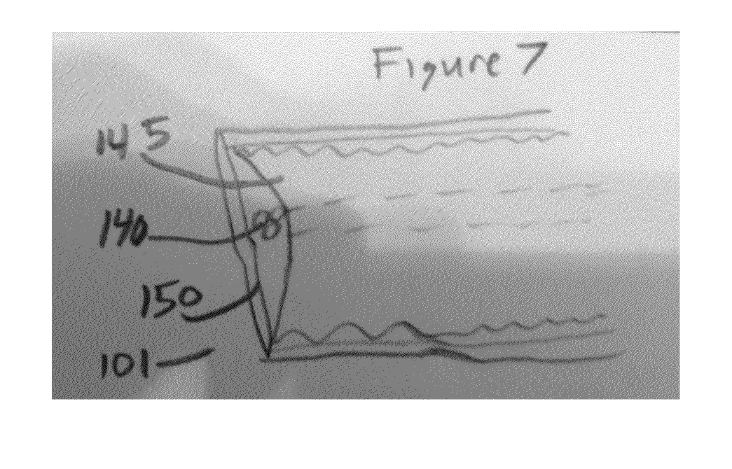

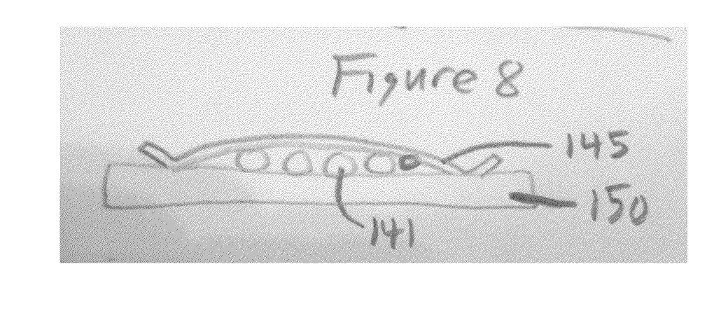

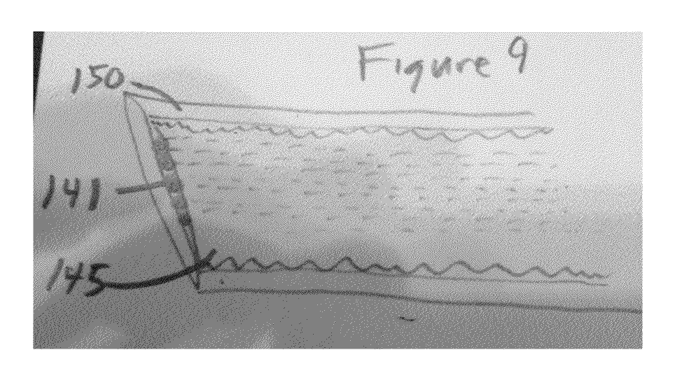

Referring to FIGS. 6, 7, 8, and 9, a harness 155, 101 with integrated wire in the form of wires 141, strands or cable 140 inside fabric layers 145 and 150. The fabric 145 cosmetically hides the wire 141, 140 and is sewn onto webbing 150.

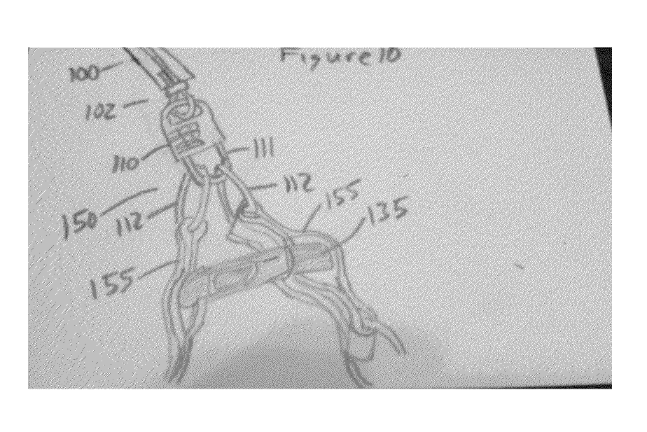

Referring now to FIG. 10, an assembly consisting of a harness 155, padlock 110, and leash 100. The harness 155 is first secured with a quick-releasing buckle or clasp 135. The padlock 110 then secures 150 the harness 155 through metal rings 112. The padlock 110 is attached to the leash 100 by looped and crimped wire 102.

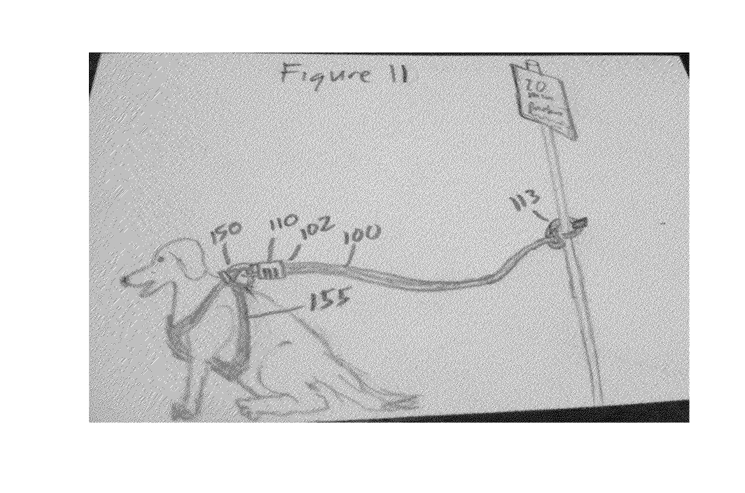

A dog is secured with the anti-theft, tamper-resistant dog harness and leash system to a street parking sign in FIG. 11. The leash 100 has been wrapped around the parking sign and threaded through itself 113. The padlock 110 is attached 102 to the leash 100 fixed at the harness 155,150.

1. An anti-theft, tamper resistant dog harness and leash system comprising:
a tubular webbing leash reinforced with integrated wires down the center providing a connection to the dog with which a user may exert a force;
a dog harness composed of tubular webbing reinforced with integrated wires down the center providing a connection of the leash to the dog;
a key or combination actuated padlock providing a locking connection between the harness and leash.

2. An anti-theft, tamper resistant dog harness and leash system according to claim 1 further comprising:
a tubular webbing leash reinforced with integrated wire strand down the center providing a connection to the dog with which a user may exert a force;
a dog harness composed of tubular webbing reinforced with integrated wire strand down the center providing a connection of the leash to the dog;
a key or combination actuated padlock providing a locking connection between the harness and leash.

3. An anti-theft, tamper resistant dog harness and leash system according to claim 1 further comprising:
a tubular webbing leash reinforced with integrated wire cable down the center providing a connection to the dog with which a user may exert a force;
a dog harness composed of tubular webbing reinforced with integrated wire cable down the center providing a connection of the leash to the dog;
a key or combination actuated padlock providing a locking connection between the harness and leash.

4. An anti-theft, tamper resistant dog harness and leash system comprising:
a webbing leash reinforced with integrated wires between the webbing and a cosmetic fabric providing a connection to the dog with which a user may exert a force;
a dog harness composed of webbing reinforced with integrated wires between the webbing and a cosmetic fabric providing a connection of the leash to the dog;
a key or combination actuated padlock providing a locking connection between the harness and leash.

5. An anti-theft, tamper resistant dog harness and leash system according to claim 1 further comprising:
a webbing leash reinforced with integrated wire strand between the webbing and a cosmetic fabric providing a connection to the dog with which a user may exert a force;
a dog harness composed of webbing reinforced with integrated wire strand between the webbing and a cosmetic fabric providing a connection of the leash to the dog;
a key or combination actuated padlock providing a locking connection between the harness and leash.

6. An anti-theft, tamper resistant dog harness and leash system according to claim 1 further comprising:
a webbing leash reinforced with integrated wire strand between the webbing and a cosmetic fabric providing a connection to the dog with which a user may exert a force;
a dog harness composed of webbing reinforced with integrated wire cable between the webbing and a cosmetic fabric providing a connection of the leash to the dog;
a key or combination actuated padlock providing a locking connection between the harness and leash.

7. An anti-theft, tamper resistant dog harness and leash system according to claim 1 further comprising:
a webbing leash reinforced with integrated wire sewn or braided into the webbing providing a connection to the dog with which a user may exert a force;
a dog harness composed of webbing reinforced with integrated wire sewn or braided into the webbing providing a connection of the leash to the dog;
a key or combination actuated padlock providing a locking connection between the harness and leash.
